(19) United States
(12) Patent Application Publication
(10) Pub. No.: US 2007/0118390 A1
(43) Pub. Date: May 24, 2007

(54) Interactive resource management educational system and method

(76) Inventor: Elizabeth A. Coit, Indianapolis, IN (US)

Correspondence Address: BAKER & DANIELS LLP, 805 15TH STREET, NW, SUITE 700, WASHINGTON, DC, 20005, US

(21) Appl. No.: 11/543,989

(22) Filed: Oct. 6, 2006

Related U.S. Application Data
(60) Provisional application No. 60/723,918, filed on Oct. 6, 2005.

(51) Int. Cl. G06Q 99/00

(52) U.S. Cl. 705/1

(57) ABSTRACT

The present invention is directed to a method and system for educating a targeted population subset in resource management. The system may include resource training components for providing the targeted population subset with information related to the resource. The system may additionally include resource acquisition components for allowing the targeted population subset to acquire a defined quantity of the resource and an interactive resource usage environment including resource depletion components that allow the targeted population subset to deplete the defined resource quantity. The system may further include resource summary output components for summarizing resource depletion for the targeted population subset.

### PRIORITY DATA

The present application claims priority to U.S. Provisional Patent Application Ser. No. 60/723,918, filed on Oct. 6, 2005.

### TECHNICAL FIELD

Embodiments of the present invention relate to an interactive educational system and method for teaching resource management. More particularly, embodiments of the invention are directed to an interactive educational system and method for promoting financial literacy.

### BACKGROUND OF THE INVENTION

Currently, in most school systems, students have the opportunity to study a basic academic curriculum that includes such subjects as English, mathematics, history, and science. However, despite an opportunity to master these traditional academic subjects, students often graduate without knowledge of how to handle everyday financial tasks.

In America each year, thousands of adults file for bankruptcy. Helping students to master financial concepts at an early age would better equip them to handle financial responsibly upon reaching adulthood. Additionally, in order to be ready for the competitive business world upon graduation, students should be provided with an opportunity to have a deep understanding of personal financial literacy. Some of the skills involved in personal financial literacy include budgeting, saving, investing, filing taxes, using credit cards responsibly, and purchasing insurance.

Although some schools do provide a financial literacy curriculum, problems frequently exist with such curricula. For instance, the materials provided by school systems to teach financial literacy are dull and fail to provide visual stimulation. Furthermore, the materials available do not include hands-on activities and exercises or interactive or computer-based games and activities. Often, the materials provided are difficult to relate to real life experiences.

Furthermore, not all teachers have the training and personal financial literacy skills necessary to successfully teach financial literacy to students. Therefore, teachers need better training and materials in order to convey financial literacy concepts. Accordingly, a system that is simple for teachers to implement is needed for interactively and dynamically educating students to avoid financial pitfalls and to manage everyday financial situations.

### BRIEF SUMMARY OF THE INVENTION

In one aspect, a system for educating a targeted population subset in resource management is provided. The system may include resource training components for providing the targeted population subset with information related to the resource and resource acquisition components for allowing the targeted population subset to acquire a defined quantity of the resource. The system may additionally include an interactive resource usage environment including resource depletion components that allow the targeted population subset to deplete the defined resource quantity. Furthermore, the system may include resource summary output components for summarizing resource depletion for the targeted population subset.

In an additional aspect, a method is provided for educating a targeted population subset in resource management. The method may include providing resource training to the targeted population subset using information related to the resource and allowing the targeted population subset to acquire a defined quantity of the resource. The method may additionally include providing interactive depletion opportunities that allow the targeted population subset to deplete the defined resource quantity and outputting a summary of resource depletion for the targeted population subset.

### BRIEF DESCRIPTION OF THE DRAWINGS

The present invention is described in detail below with reference to the attached drawings figures, wherein:

FIG. 1 is a block diagram illustrating components of an interactive educational system in accordance with an embodiment of the invention;

FIG. 2 is a flow chart illustrating a method of educating a targeted population subset in accordance with an embodiment of the invention;

FIG. 3 is block diagram illustrating components of an educational system computing environment in accordance with an embodiment of the invention;

FIG. 4 is a block diagram illustrating components of a resource training system in accordance with an embodiment of the invention;

FIG. 5 is a block diagram illustrating further components of a resource training system in accordance with an embodiment of the invention;

FIGS. 6A and 6B are diagrams illustrating interactive resource training components in accordance with an embodiment of the invention;

FIG. 7 is a diagram illustrating a layout of interactive resource depletion components in accordance with an embodiment of the invention;

FIG. 8 is a graphic illustration of an exemplary interactive resource depletion component in accordance with an embodiment of the invention; and

FIG. 9 is a graphic illustration of an additional interactive resource depletion component in accordance with an embodiment of the invention.

### DETAILED DESCRIPTION OF PREFERRED EMBODIMENTS

Embodiments of the present invention are directed to a system and method for providing resource management training and in particular for providing training for management of financial resources.

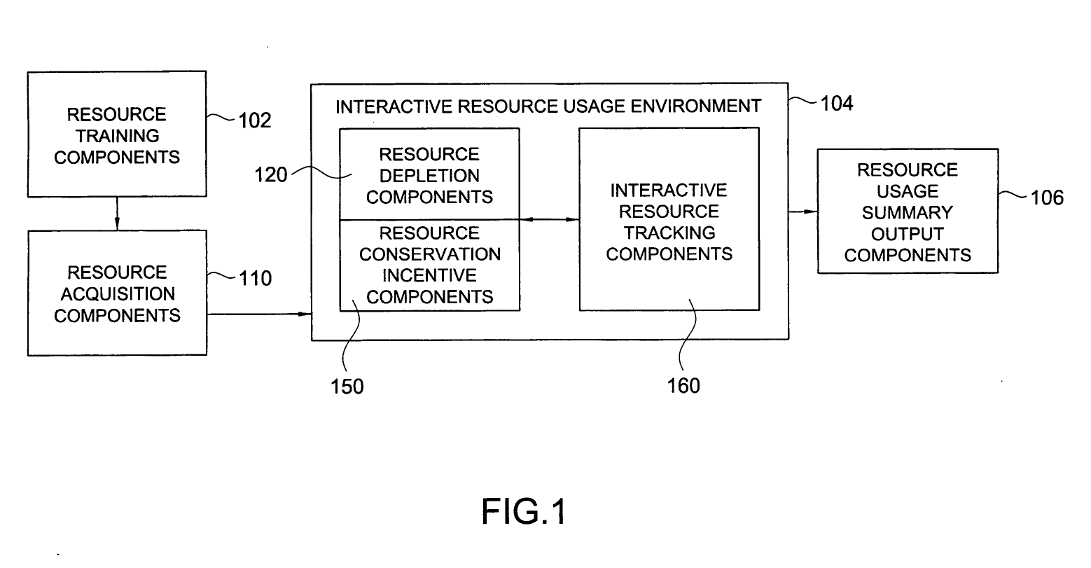

FIG. 1 is a block diagram illustrating components of a system and method for providing resource management training in accordance with an embodiment of the invention. Resource training components 102 may be implemented to educate participants prior to the provision of interactive opportunities. Resource acquisition components 110 allow participants to acquire a defined resource quantity. After resource acquisition, participants may enter an interactive resource usage environment 104. The interactive resource usage environment 104 may include resource depletion components 120, resource conservation incentive components 150, and interactive resource tracking components 160. The interactive resource tracking components 160 may track depletion and conservation of resources for each participant. Resource usage summary output components 106 may output a summary of resource interaction for each participant when the participant has completed the interactive usage experience.

In embodiments of the invention, the resource training components 102 may include classroom lessons and/or interactive lessons outside of the classroom. In a program to provide financial literacy instruction, the resource training components 102 may include classroom instruction related to money, personal spending, budgeting, saving, checking, etc. For instance, the resource training components 102 may explain distinctions between keeping money in a checking account, keeping money in a savings account, and keeping cash. The resource training components 102 may additionally provide instructions for withdrawing and depositing money from a bank by providing sample withdrawal and deposit slips for participants to complete. The resource training components 102 may also teach the distinctions between debit cards and credit cards. Budgetary planning may also be included in the resource training components 102. The budgetary planning may take into consideration the costs of each interactive activity, acquired resources, savings goals, and spending priorities. The resource training components 102 may additionally instruct participants with regard to how to interpret and verify bank statements. In embodiments of the invention, the resource training components 102 may also provide instruction regarding basic business concepts and entrepreneurial skills.

The resource acquisition components 110 may allow participants to obtain a defined quantity of a resource. In embodiments of the invention, the resource acquisition components 110 allow participants to select jobs that provide a paycheck in order to allow participants to acquire resources. For example, if the participants are elementary school students, the resource acquisition components 110 may provide a choice of summer jobs having varying hours and rates of pay. For young participants, such jobs may include yard work, lemonade stands, washing cars, house sitting, household chores, and pet care. Each job may pay based on a task basis, weekly basis, hourly basis, or other type of pay arrangement. Participants may select between available jobs and acquire financial resources in accordance with the terms of the selected job.

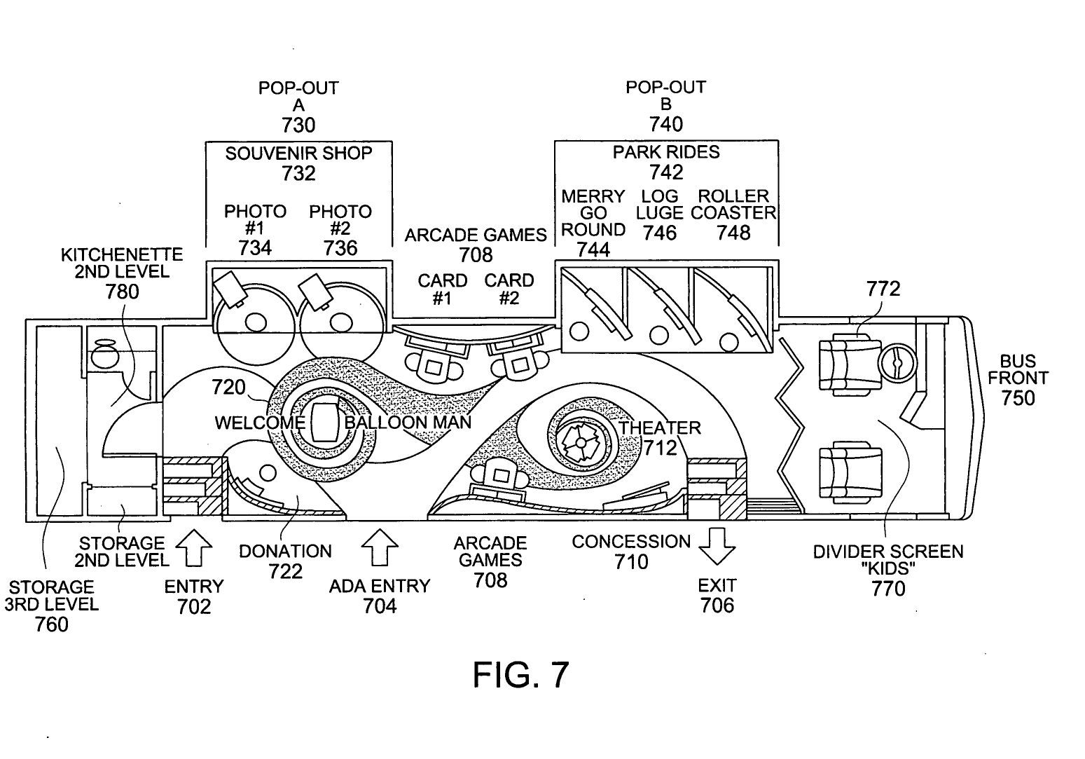

After acquiring training through the resource training components 102 and acquiring resources through the resource acquisition components 110, participants may enter the interactive usage environment 104. The interactive usage environment 104 preferably provides entertaining and interactive opportunities for participants to use resources. In particular, resource depletion components 120 may include games and concessions, all of which deplete resources to a predetermined extent. The resource depletion components 120 will be further described further with reference to a preferred embodiment as illustrated in FIG. 7.

The interactive resource usage environment 104 may also include resource conservation incentive components 150. These resource conservation incentive components 150 may provide incentives for participants to conserve resources. Such incentives may be in the form of rewards, or extra concessions or games if participants select a less expensive depletion opportunity.

The interactive resource tracking components 160 may track resource depletion allowed by the aforementioned components. This tracking function may be computerized. For instance, resource depletion may occur through the use of a card, such as stored value, credit, or debit card. Participants may alternatively be issued personalized tokens that are tracked by the interactive resource tracking components 160. The resource tracking components 160 may track this activity electronically. The resource usage summary output components 106 may provide a summary of resource usage.

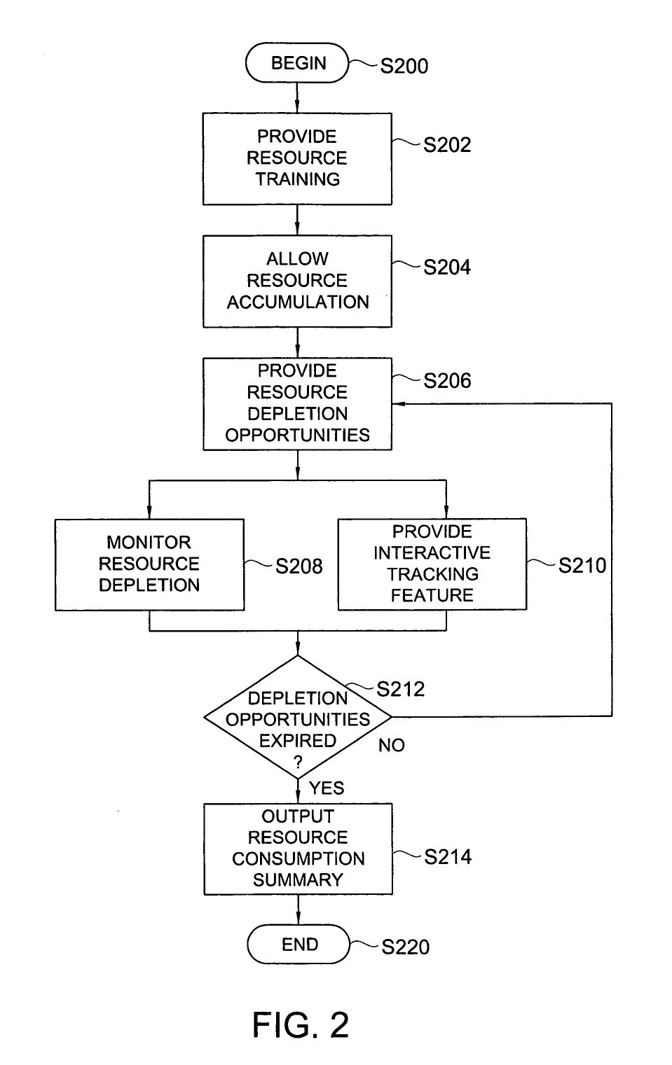

FIG. 2 is a flow chart illustrating a method for providing resource management instruction in accordance with an embodiment of the invention. The method begins in S200 and resource training is provided in S202. In S204 the method allows resource accumulation, which may occur as set forth above through providing participants with job opportunities. In embodiments of the invention, the order of the aforementioned steps may be inverted. In S206, participants are provided with resource depletion opportunities, which are preferably interactive opportunities. In S208 and S210, resource depletion is monitored and interactive tracking is implemented. The interactive tracking features of S210 may maintain a record of which activities and depletion opportunities participants selected. In S212, the method determines whether depletion opportunities have expired. Expiration of depletion opportunities may be based upon time expiration, resource expiration, participation in a predetermined number of activities, or any other selected factor. If depletion opportunities have not expired, the monitoring and tracking continue. Once depletion opportunities have expired in S212, a resource consumption summary is output in S214. The process ends in S220. In general, where possible, the order of the aforementioned steps may be altered as appropriate.

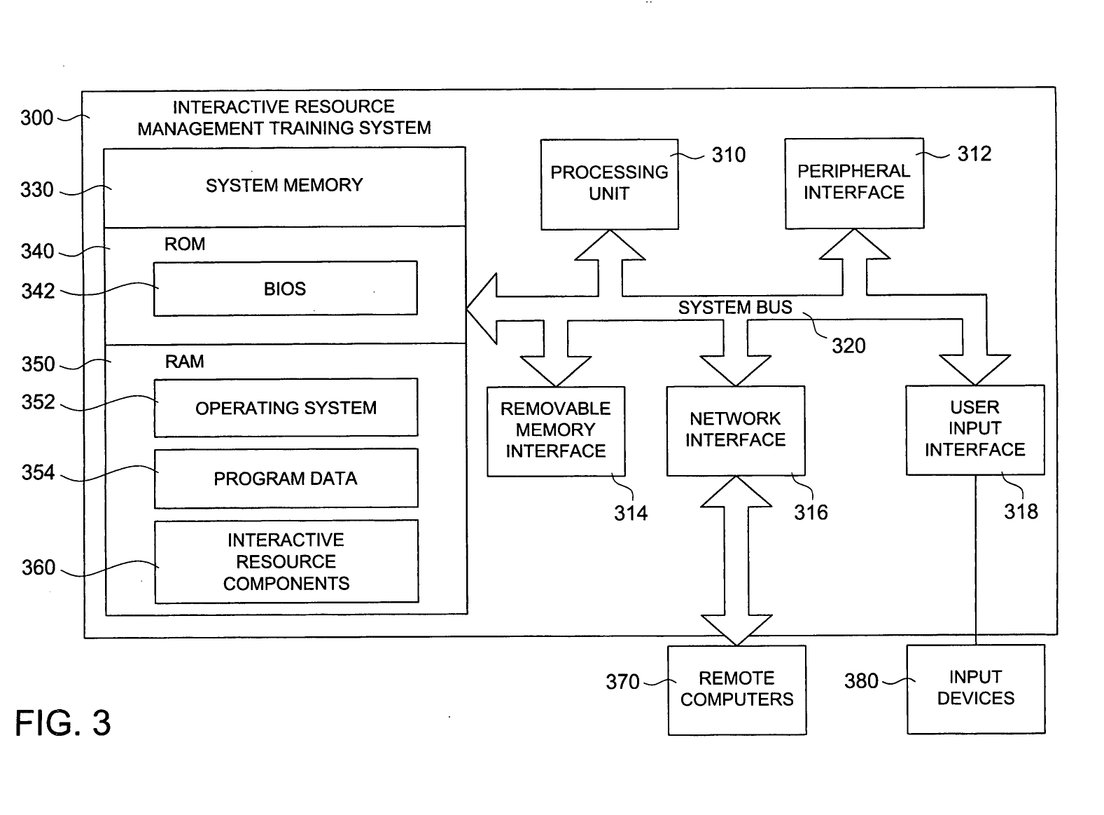

FIG. 3 illustrates details of an interactive resource management training system 300 in accordance with an embodiment of the invention. The interactive resource management training system 300 is illustrated as incorporating a single computer system in the displayed preferred embodiment. However, in additional preferred embodiments, the interactive resource management training system 300 will be distributed over multiple computing devices. Those computing devices will have components similar to those displayed in FIG. 3.

In the illustrated system, the interactive resource management training system 300 may include a processing unit 310, a peripheral interface 312, a removable memory interface 314, a network interface 316, and a user input interface 318. The interactive resource management training system 300 may also include a memory 330. A system bus 320 may be used to couple the aforementioned components.

The system memory 330 may include computer storage media in the form of volatile and/or nonvolatile memory such as read only memory (ROM) 340 and random access memory (RAM) 350. A basic input/output system (BIOS) 342, containing the basic routines that help to transfer information between elements within the interactive resource management training center 300, such as during start-up, is typically stored in ROM 340. RAM 350 typically contains data and/or program modules that are immediately accessible to and/or presently being operated on by processing unit 310.

The RAM 350 may include an operating system 352, program data 354, and interactive resource components 360. The interactive resource components 360 and any other application programs stored in RAM 350 may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

The interactive resource management training system 300 may also include other removable/non-removable, and volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus 320 through a non-removable memory interface. The magnetic disk drive and optical disk drive are typically connected to the system bus by a removable memory interface.

A user may enter commands and information through the user input interface 318 using input devices such as a keyboard and pointing device, commonly referred to as a mouse, trackball or touch pad. Other input devices may include a microphone, satellite dish, scanner, bar code reader, RFID tag reader or the like. In embodiments of the invention, participants may store resources on a stored value card and the input device will include a device for reading and depleting the stored value. These and other input devices are often connected to the processing unit 310 through the user input interface 318 that is coupled to the system bus 320, but may be connected by other interface and bus structures, such as a parallel port or a universal serial bus (USB). A monitor or other type of display device and other peripherals may also be connected to the system bus 320 via an interface, such as the peripheral interface 312.

The illustrated interactive resource management training system 300 is merely an example of a suitable environment for the system of the invention and is not intended to suggest any limitation as to the scope of use or functionality of the invention. Neither should the interactive resource management training system 300 be interpreted as having any dependency or requirement relating to any one or combination of components illustrated.

The interactive resource management training system 300 in embodiments of the present invention may operate in a networked environment using logical connections to communicate with networked components. Logical connections for networking may include a local area network (LAN) or a wide area network (WAN), but may also include other networks. When used in a LAN networking environment, the system may be connected to the LAN through the network interface 316 or adapter. When used in a WAN networking environment, the interactive resource management training system 300 typically includes a modem or other means for establishing communications, such as the Internet. The modem, which may be internal or external, may be connected to the system bus 320 via the user input interface 318 or other appropriate mechanism.

Although the interactive resource management training system 300 has been described in detail with respect to the appropriate computerized environment, it should be understood that the other components shown in FIG. 3 operate in a similar computerized environment.

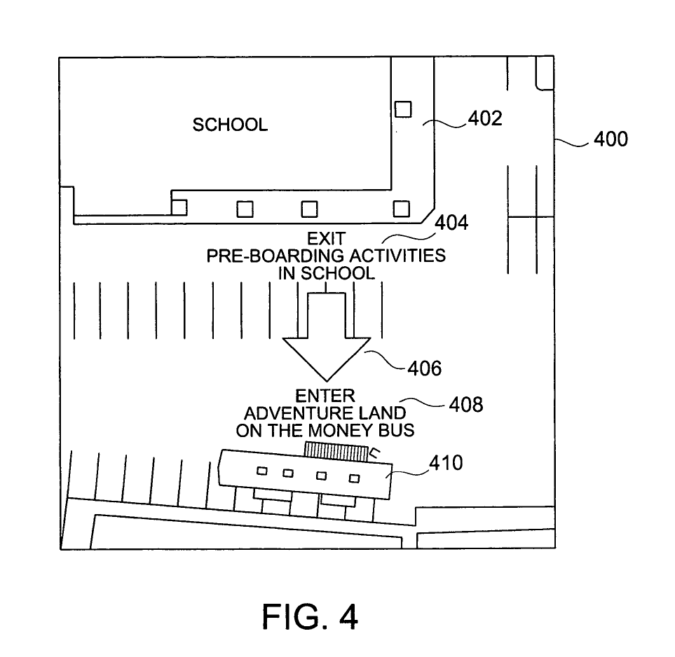

FIG. 4 is a diagram illustrating a transition from the resource training components 102 and resource acquisition components 110 to the interactive resource usage environment 104. The resource training components may be provided, for example, within a school 402 and may extend through a school exit 404. Participants may progress at 406 from the in-school environment to an entry 408 for the interactive environment 410. In embodiments of the invention, the interactive environment 410 is a mobile environment, such as for example, a bus.

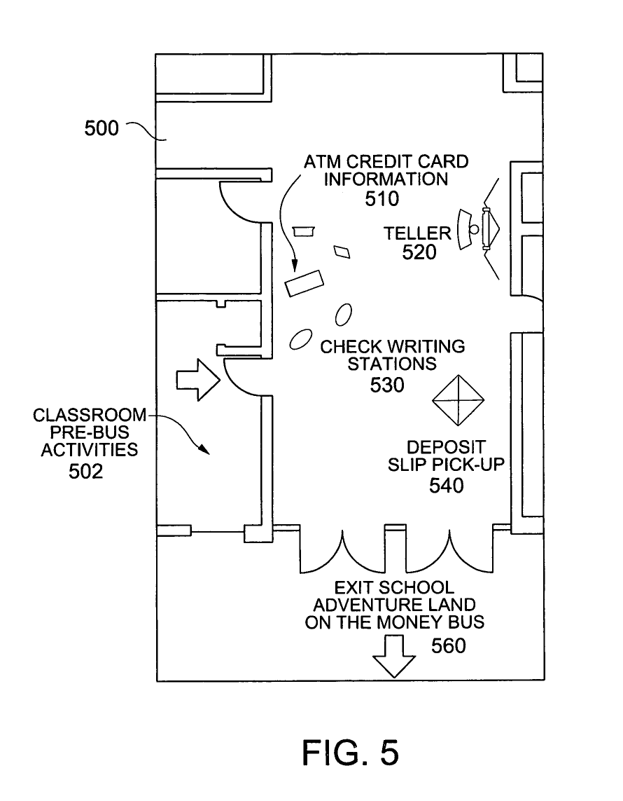

FIG. 5 illustrates resource training components 102 in still greater detail. A training environment 500 may include various classroom, pre-bus activities 502. These may include various financial education activities. Furthermore, an ATM/credit card information area 510, a teller area 520, check writing stations 530, and a deposit slip pick-up area 540 may be included. The ATM/credit card information area 510 may include an interactive experience through a device such as an informational kiosk. The check writing stations 530 may interactively teach check writing. The teller area 510 may allow students to set up their savings and checking accounts at the teller station. This account information will be imputed by the teller and subsequently activated by computer. Once participants have visited the aforementioned areas, the participants may depart through exit 560 toward the interactive mobile resource management environment. Thus, participants will have their debit card, credit card, money, and checks to use in the interactive mobile resource management environment.

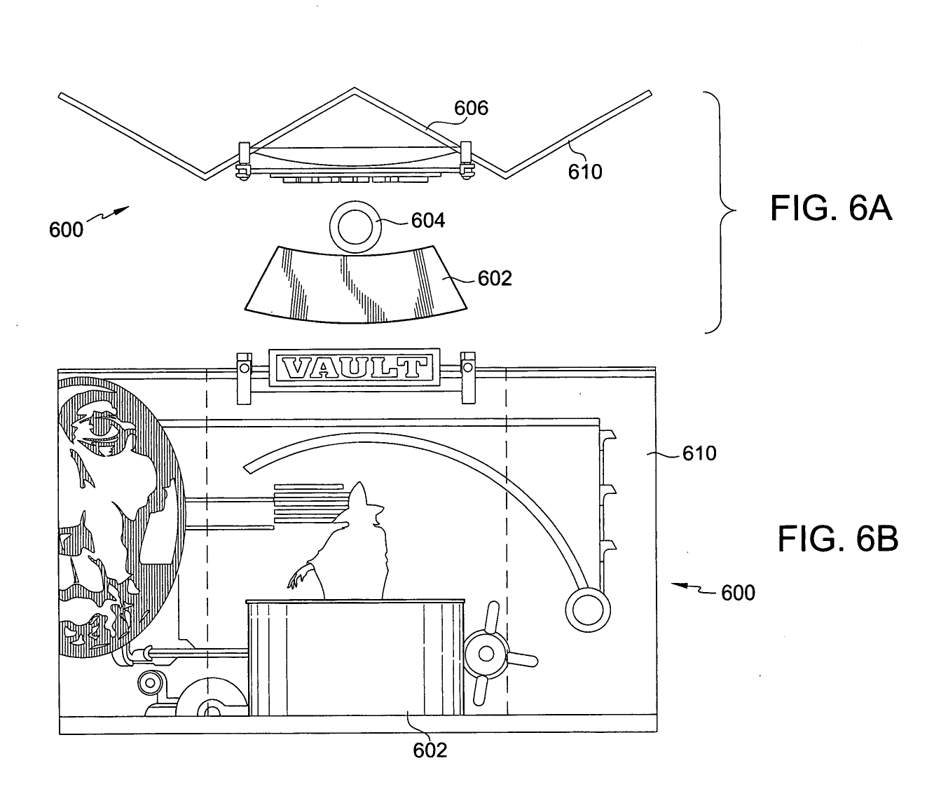

FIGS. 6A and 6B illustrate a teller area 600 in greater detail. FIG. 6A is a plan view illustrating teller customer interaction area or counter 602, attended by a teller 604. The teller 604 may have access to bank resources 606 and be flanked by a backdrop 610. FIG. 6B is a graphic illustration of the same components. As illustrated, the teller area 600 should provide a visually stimulating and interactive experience. In embodiments of the invention, the teller may include a computer implemented game or similar interactive experience.

Before entering the mobile interactive resource environments, participants may be required to wait in a line. Thus, an inspirational queuing area may be provided in the transition area. Participants may have the opportunity to read stories about children earning money while standing in line. The line may end with a ticket booth at which students may have the option to pay extra money to avoid waiting in line. Thus participants will have to assess the value of avoiding the wait.

FIG. 7 illustrates an interactive resource management training environment 700 in accordance with an embodiment of the invention. The interactive resource management training area 700 may be a mobile apparatus such as a bus, configured to provide participants with an interactive education resource management experience, such for example, financial management education. The environment 700 may include a bus front 750, where seats are provided for a driver and passenger. A divider screen 770 may separate participants from the driver and passenger. In addition to the interactive areas, the bus preferably includes at least one storage area 760 and a kitchen area 780.

Participants may enter the interactive training environment 700 through an entryway, such as entryway 702. An entryway 704 may also be provided that allows handicapped access in order to comply with the Americans with Disabilities Act (ADA). A welcome area 720 may be provided that introduces participants to the interactive environment 700. The welcome area 720, in embodiments of the invention may include a multi-sided kiosk. In one graphic representation, this multi-sided kiosk is a “balloon man” kiosk that features a man on stilts holding a scroll that reads “Welcome to the Money Bus”. On opposite sides of the kiosk, there may be additional kiosks with an ATM/information area where participants can use computer screens to check on their savings and checking accounts. Students may be required to swipe a card to determine the value.

Opportunities for resource depletion may occur in a donation area 722, arcade games 708, concession area 710, and theater 712. The concession area 710 may allow students to choose concessions at different prices. For example, students may build their own ice cream cones. Each individual ingredient may have its own costs and participants must add the various costs together and pay the final total.

In the donation area 722, participants have the opportunity to learn about donating to charities. In embodiments of the invention, a memory board game may be presented on a game board having multiple organizations represented. A community organization would be represented on two buttons randomly placed on the board. Participants turn over the buttons to reveal a charitable organization and then find the same buttons amongst the remaining buttons to obtain more information about the charitable organization. The turning over of buttons may include audio and visual feedback. Participants then may be asked whether or not they choose to contribute to the charity.

Arcade games 708 provide participants with an opportunity to make decisions about wants and needs. Participants may be given choices between junk food and nutritious foods, or may be sent on a treasure hunt and required to classify found items in terms of wants and needs. Participants may work as a team to complete this exercise and further may be able to select an ability level based on grade or age.

Sides of the bus may include pop-out areas 730 and 740 that may be utilized to create a larger interactive environment when the bus is stationary. Pop-out area 730 may include a souvenir shop 732 including photo areas 734 and 736. The photo areas 734 and 736 may be available for participants to enter upon payment of a predefined resource quantity. The souvenir shop 732 may give participants the opportunity to make choices between souvenirs that are expensive, moderate, or inexpensive in price. For example, participants may have the option of buying their own photographs and putting them on a t-shirt, keychain, ball cap, or coffee much for an additional fee. Based on “two for one” pricing advertisements in this area, participants may learn to make intelligent spending choices.

The pop-out area 740 preferably includes amusement park rides 742. The amusement park rides 742 may include a merry go round 744, a log luge 746, and a roller coaster 748. Other rides may also be included. For each ride, participants may be required to submit a predefined resource quantity. The resource quantity may be submitted electronically, such as through a stored value card, credit card, or debit card and through the use of an appropriate card reader. The park rides 742 may have financial themes. For example, the roller coaster 748 may be a savings account roller coaster ride. The ride may climb or rise to a peak. While it is rising, different dollar levels may be passed. For instance, the ride may first pass a $1 savings level, and continue through a $2 savings level, to $5 at a peak. At the peak, participants may have the opportunity to decide whether to spend the money in order to continue on the ride. In embodiments of the invention, participants may be rewarded with another ride if they choice to save the money. The ride may include a soundtrack describing savings and further may include graphics showing the rise and fall of the savings account.

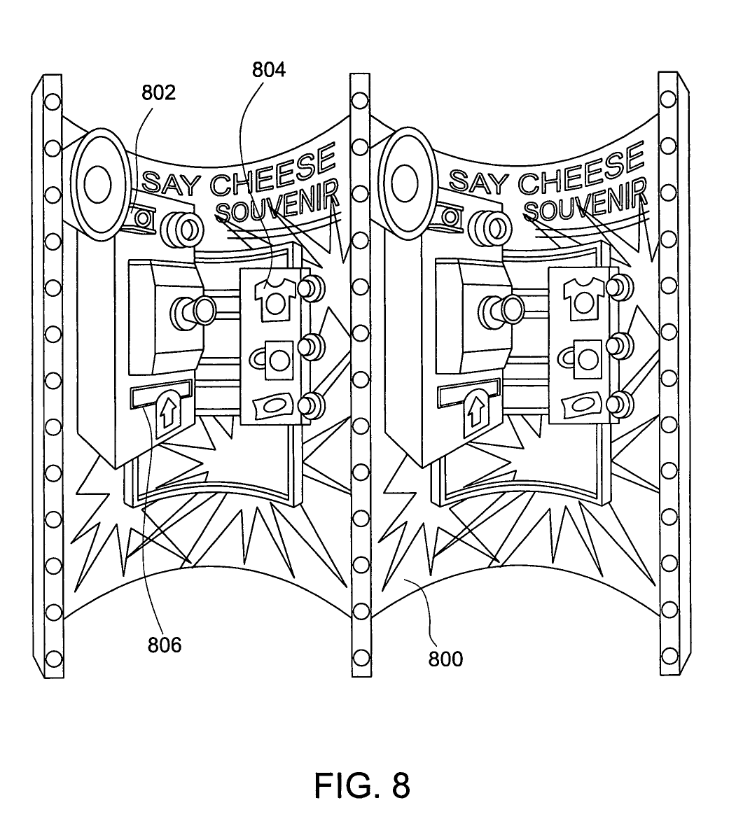

FIG. 8 is a graphic illustration of a souvenir area 800. The souvenir area 800 may include a camera area 802 and a souvenir purchase area 804. These areas may be utilized upon the user entering a predefined resource quantity through an entry mechanism such as the slot 806. In embodiments of the invention, the slot 806 is a card reading slot for reading a participant's stored value card. Alternatively, the slot 806 may be a coin slot or a token slot, through which a coin or token having a predetermined value may be inserted.

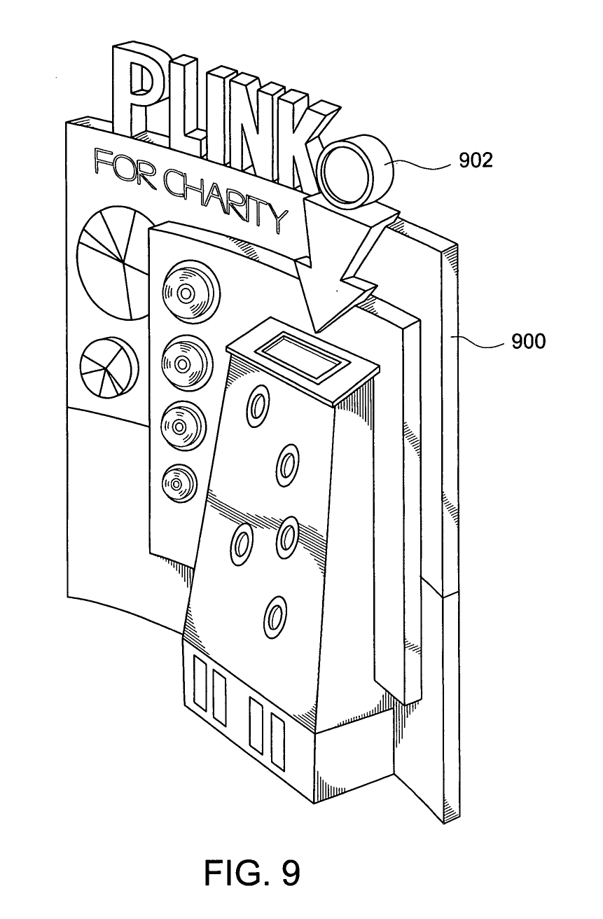

FIG. 9 is a graphic illustration of a charity donation center 900. The charity donation center 900 may provide a display containing information regarding various charities and also may include a slot 902 for accepting a predefined resource quantity. As set forth above, the slot 902 may contain necessary components to read a stored value card, credit card, debit card or other type of card. Alternatively, the slot 902 may be a slot for depositing a coin or token having a predetermined value.

The interactive resource management training environment as described herein provides participants interactive experience to facilitate learning. The opportunity to earn and deplete resources in the described manner is an effective technique for teaching financial responsibility and literacy.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A system for educating a targeted population subset in resource management, the system comprising:
resource training components for providing the targeted population subset with information related to the resource;
resource acquisition components for allowing the targeted population subset to acquire a defined quantity of the resource;
an interactive resource usage environment including resource depletion components that allow the targeted population subset to deplete the defined resource quantity; and
resource summary output components for summarizing resource depletion for the targeted population subset.

2. The system of claim 1, wherein the interactive resource usage environment comprises a mobile environment.

3. The system of claim 1, wherein the resource comprises money.

4. The system of claim 3, wherein the resource training components comprise banking education components.

5. The system of claim 4, wherein the banking education components teach the targeted population subset concepts related to checking accounts, savings accounts, debit cards, and credit cards.

6. The system of claim 1, wherein resource acquisition components comprise job experiences for acquiring a financial resource.

7. The system of claim 6, wherein the resource depletion components comprise spending opportunities.

8. The system of claim 7, wherein the spending opportunities comprise opportunities to purchase concessions, souvenirs, and amusement park rides.

9. The system of claim 7, wherein the spending opportunities comprise opportunities to make charitable donations.

10. The system of claim 7, further comprising interactive resource tracking components within the interactive resource usage environment for tracking spending for each member of the target population subset.

11. A method for educating a targeted population subset in resource management, the method comprising:
providing resource training to the targeted population subset using information related to the resource;
allowing the targeted population subset to acquire a defined quantity of the resource;
providing interactive depletion opportunities that allow the targeted population subset to deplete the defined resource quantity; and
outputting a summary of resource depletion for the targeted population subset.

12. The method of claim 11, wherein providing interactive depletion opportunities comprises providing a mobile depletion environment.

13. The method of claim 11, wherein the resource comprises money.

14. The method of claim 13, further comprising providing banking education components as the resource training.

15. The method of claim 14, wherein the banking education teaches the target sub-population concepts related to checking accounts, savings accounts, debit cards, and credit cards.

16. The method of claim 11, wherein allowing the targeted population subset to acquire a defined quantity of the resource comprises providing job experiences for acquiring a financial resource.

17. The method of claim 16, wherein the interactive depletion opportunities comprise spending opportunities.

18. The method of claim 17, wherein the spending opportunities comprise opportunities to purchase concessions, souvenirs, and amusement park rides.

19. The method of claim 17, wherein the spending opportunities comprise opportunities to make charitable donations.

20. The method of claim 17, further comprising interactively tracking spending for each member of the target population subset.
